(19) United States
(12) Patent Application Publication
(10) Pub. No.: US 2013/0286541 A1
(43) Pub. Date: Oct. 31, 2013

(54) LAMINATED SEMICONDUCTOR CERAMIC CAPACITOR WITH VARISTOR FUNCTION AND METHOD FOR MANUFACTURING THE SAME

(71) Applicant: MURATA MANUFACTURING CO., LTD., Nagaokakyo-Shi (JP)

(72) Inventor: Mitsutosho Kawamoto, Nagaokakyo-shi (JP)

(21) Appl. No.: 13/929,905

(22) Filed: Jun. 28, 2013

Related U.S. Application Data
(63) Continuation of application No. PCT/JP2012/051779, filed on Jan. 27, 2012.

(30) Foreign Application Priority Data
Feb. 4, 2011 (JP) 2011-022504

(51) Int. Cl. H01G 4/12

(52) U.S. Cl. CPC H01G 4/1281
USPC 361/321.4; 156/89.12

(57) ABSTRACT

A laminated semiconductor ceramic capacitor with a varistor function includes a component body having a plurality of semiconductor ceramic layers formed of a SrTiO₃-based grain boundary insulated semiconductor ceramic and a plurality of internal electrode layers predominantly composed of Ni, and external electrodes on both ends of the component body. The external electrodes are electrically connected to the internal electrode layers. A thickness of each of the semiconductor ceramic layers, excluding the outermost semiconductor ceramic layers, is 20 μm or more, and an average grain diameter of crystal grains in the semiconductor ceramic layers is 1.5 μm or less. When a central part or the vicinity of the central part in a laminating direction of the semiconductor ceramic layer is analyzed by a WDX method, a ratio x/y of the intensity x of the Ni element to the intensity y of the Ti element is 0.06 or less.

### CROSS REFERENCE TO RELATED APPLICATIONS

The present application is a continuation of International application No. PCT/JP2012/051779, filed Jan. 27, 2012, which claims priority to Japanese Patent Application No. 2011-022504, filed Feb. 4, 2011, the entire contents of each of which are incorporated herein by reference.

### FIELD OF THE INVENTION

The present invention relates to a laminated semiconductor ceramic capacitor with a varistor function and a method for manufacturing the same, and more particularly relates to a laminated semiconductor ceramic capacitor with a varistor function where a SrTiO₃ based grain boundary insulated semiconductor ceramic is used for the varistor function, and a method for manufacturing the same.

### BACKGROUND OF THE INVENTION

In recent years, with the development of electronics technology, mobile electronic devices such as cellular phones and laptop personal computers, and in-car electronic devices to be installed on cars have becoming common, and the reduction in size with multifunctionalization has been required for the electronic devices.

On the other hand, in order to achieve the reduction in size with multifunctionalization for the electronic devices, more semiconductor elements have been used such as various types of ICs and LSI, and accordingly, the electronic devices have been decreasing their noise immunity.

Thus, conventionally, power lines for semiconductor elements are provided with a film capacitor, a laminated ceramic capacitor, a laminated semiconductor ceramic capacitor, or the like as a bypass capacitor, thereby to ensure the noise immunity to the electronic devices.

In particular, in the case of car navigation systems, car audio systems, in-car ECUs, etc., what is commonly the case is that a capacitor with a capacitance on the order of 1 nF is connected to an external terminal, thereby to absorb high-frequency noises.

However, while these capacitors deliver superior performance on the absorption of high-frequency noises, the capacitors themselves have no function of absorbing high-voltage pulses or static electricity. For this reason, if the high-voltage pulses or static electricity are input to the electronic devices, there is a possibility that the high-voltage pulses or static electricity may cause the electronic device to malfunction or cause the semiconductor elements to be broken. In particular, when the capacitor has a low capacitance on the order of 1 nF, since an ESD (electro-static discharge) withstand voltage is extremely low (for example, about 2 to 4 kV), there is a possibility that this may cause the capacitor itself to be broken.

Thus, conventionally, as shown in FIG. 5, what is commonly the case is that a bypass capacitor 104 is disposed to a power source line 103 being connected between an external terminal 101 and a semiconductor element 102, and a zener diode 105, for example, is connected to the power source line 103 in parallel to the bypass capacitor 104. The zener diode 105 plays a role in protecting the bypass capacitor 104 and protecting the semiconductor element 102, and thereby, the ESD withstand voltage is ensured to protect the semiconductor element 102.

However, when the zener diode 105 is disposed in parallel to the bypass capacitor 104 as described above, the number of components is increased to cause an increase in cost, and moreover, the space for the placement of the components has to be secured, and there is a possibility that an increase in the size of the device may be caused.

On the other hand, a SrTiO₃-based grain boundary insulated laminated semiconductor ceramic capacitor is known to have a varistor characteristic, and receives attention as a countermeasure item for ESD since an application of a voltage of a certain level or more allows a large current to flow.

Accordingly, if this type of the laminated semiconductor ceramic capacitor can provide not only the immunity to ESD but also the protection of a semiconductor element 102, only one laminated semiconductor ceramic capacitor 106 can cover these functions in place of conventional capacitors and zener diodes as shown in FIG. 6. Thereby, the number of components or cost is reduced, and standardization of design is facilitated, and therefore a capacitor having added values can be provided.

In Patent Document 1 is proposed a laminated semiconductor ceramic capacitor with a varistor function which includes a laminated sintered body obtained by alternately laminating and firing a plurality of semiconductor ceramic layers formed of a SrTiO₃-based grain boundary insulated semiconductor ceramic and a plurality of internal electrode layers, and external electrodes on both ends of the laminated sintered body, the external electrodes electrically connected to the internal electrode layers, wherein the semiconductor ceramic has a compounding molar ratio m of a Sr site to a Ti site satisfying the relational expression 1.000<m≦1.020, a donor element is solid-solved in crystal grains, an acceptor element is present in a grain boundary layer in the range of 0.5 mol or less (however, not including 0 mol) with respect to 100 mol of the Ti element, and an average grain diameter of the crystal grains is 1.0 μm or less.

In Patent Document 1, Ni is used for an internal electrode material, a thickness per a layer of semiconductor ceramic layers is set to 13 μm, and the number of lamination is set to 10, thereby preparing a semiconductor ceramic capacitor. Consequently, a laminated semiconductor ceramic capacitor having a varistor function, which has such good electrical characteristics that the apparent relative permittivity εr_{APP} is 1000 or more and such good insulating properties that the specific resistances log ρ is 9.5 or more, and is capable of ensuring an ESD withstand voltage of 30 kV or more and is suitable for compact size/low capacity, was attained.

Further, in Patent Document 2 is proposed a method for manufacturing a grain boundary insulated semiconductor laminated ceramic capacitor comprising the steps of: calcining a ceramic material containing a principal component for preparing a semiconductor ceramic or a substance for obtaining the principal component, and a promoter for bringing into a semiconductor in an oxidizing atmosphere; forming a ceramic raw sheet by using the calcined ceramic material; applying a conductive paste incorporating a substance for making a grain boundary of the semiconductor ceramic insulated onto a main surface of the ceramic raw sheet; laminating a plurality of the ceramic raw sheets having the conductive paste applied to form a laminate; firing the laminate in a reducing atmosphere to obtain a sintered body; and heat-treating the sintered body at a temperature of 900 to 1200° C. in a weakly oxidizing atmosphere.

In Patent Document 2 is obtained a laminated semiconductor ceramic capacitor having a varistor function in which a raw sheet (having a thickness of 60 μm) laminate having a paste-applied layer is prepared from a ceramic material calcined at a temperature of 1150° C. in an atmosphere of the air, and the raw sheet laminate is subjected to primary firing at 1300° C. in a reducing atmosphere, and then subjected to secondary firing at 1000° C. in a weakly oxidizing atmosphere, and thereby, a base metal material such as Ni can be used as an internal electrode material.
Patent Document 1: WO 2008/004389 A (claim 1, paragraphs [0100], [0112], Table 1)
Patent Document 2: JP 5-36561 A (claim 1, paragraphs [0015]-[0022])

### SUMMARY OF THE INVENTION

By the way, in Patent Document 1, Ni is used as an internal electrode material, and it was found from the investigation results of the present inventor that Ni is diffused into a semiconductor ceramic layer side during firing. However, since the Ni acts as an acceptor in terms of electric charge, there is a possibility that the apparent relative permittivity εr_{APP} or the insulation resistance may be reduced and electrical characteristics or insulating properties may be deteriorated when the amount of Ni to be diffused into the ceramic layer is increased. Further, since the electrical characteristics or the insulating properties vary according to the amount of Ni diffused, variations in characteristics may also be produced between products.

In Patent Document 2, a firing temperature in a primary firing treatment is higher than a calcining temperature, and therefore there is a possibility that the grain growth of crystal grains may be promoted and the crystal grain may become larger during the primary firing treatment. When the crystal grain becomes larger as described above, oxygen hardly goes round in the grain boundary layer during secondary firing, and therefore a grain boundary insulated layer having large specific resistance cannot be achieved.

Further, in Patent Document 2, since the firing temperature in the primary firing treatment is as high as 1300° C., diffusion of Ni of an internal electrode material into the semiconductor ceramic layer side is promoted though the thickness of a raw sheet is as large as 60 μm, and therefore there is a possibility that the crystal grain may become larger and reduction of insulating properties may be advanced.

The present invention was made in view of such a situation, and it is an object of the present invention to provide a laminated semiconductor ceramic capacitor with a varistor function which has small variations in characteristics between products, can stably obtain good electrical characteristics and insulating properties, and has good reliability, and a method for manufacturing the laminated semiconductor ceramic capacitor with a varistor function.

The present inventor made earnest investigations by using a base metal material principally composed of Ni for an internal electrode material concerning a SrTiO₃-based grain boundary insulation type laminated semiconductor ceramic capacitor in order to achieve the above-mentioned object. Consequently, the present inventor obtained findings that by specifying a thickness of each of the semiconductor ceramic layers so as to be 20 μm or more, and specifying an average grain diameter of crystal grains in the semiconductor ceramic so as to be 1.5 μm or less, it is possible to stably obtain a semiconductor ceramic capacitor which can suppress variations in characteristics between products, and thereby has good electrical characteristics and insulating properties to be excellent in reliability.

The present invention was made based on these findings, and the laminated semiconductor ceramic capacitor with a varistor function (hereinafter, referred to just as a “laminated semiconductor ceramic capacitor”) of the present invention is a laminated semiconductor ceramic capacitor with a varistor function comprising a laminated sintered body obtained by alternately laminating and sintering a plurality of semiconductor ceramic layers formed of a SrTiO₃-based grain boundary insulated semiconductor ceramic and a plurality of internal electrode layers predominantly composed of Ni, and external electrodes on both ends of the laminated sintered body, the external electrodes electrically connected to the internal electrode layers, wherein a thickness of each of the semiconductor ceramic layers is 20 μm or more, and an average grain diameter of crystal grains in the semiconductor ceramic layers is 1.5 μm or less.

By specifying a thickness of each of the semiconductor ceramic layers and an average grain diameter of crystal grains as described above, in combination of both of the resultant effects, it is possible to stably obtain, with a high degree of efficiency, a laminated semiconductor ceramic capacitor which can suppress variations in characteristics between products, and thereby has good electrical characteristics and insulating properties resulting in excellent reliability, and is suitable for supporting ESD.

Further, an elemental analysis of a central part or the vicinity of the central part in a laminating direction of the semiconductor ceramic layer was performed by a wavelength dispersive fluorescent X-ray spectroscopy (hereafter, referred to as “WDX”) method, and consequently it was found that when the thickness of the semiconductor ceramic layer is 20 μm or more, a ratio x/y of the intensity x of the Ni element to the intensity y of the Ti element can be reduced to 0.06 or less. Accordingly, by forming, in the semiconductor ceramic layer, a zone of an area in which the ratio x/y of the intensity x of the Ni element to the intensity y of the Ti element is 0.06 or less, the impact of Ni diffusion on the characteristics can be precluded as far as possible.

That is, in the laminated semiconductor ceramic capacitor of the present invention, it is preferred that the ratio x/y of the intensity x of the Ni element to the intensity y of the Ti element is 0.06 or less when the central part or the vicinity of the central part in a laminating direction of the semiconductor ceramic layer was analyzed by the WDX method.

Thereby, it becomes possible to reduce a Ni concentration in the central part or the vicinity of the central part of the semiconductor ceramic layer to the extent of having no effect on the characteristics.

Further, in the laminated semiconductor ceramic capacitor of the present invention, the semiconductor ceramic preferably has a compounding molar ratio m of a Sr site to a Ti site, which satisfies the relational expression 0.990≦m≦1.010, has a donor element solid-solved in crystal grains, and has an acceptor element present in a grain boundary layer preferably in the range of 0.7 mol or less (however, not including 0 mol) with respect to 100 mol of the Ti element.

Moreover, in the laminated semiconductor ceramic capacitor of the present invention, the acceptor element is preferably contained in an amount of 0.3 mol to 0.5 mol with respect to 100 mol of the Ti element.

Further, in the laminated semiconductor ceramic capacitor of the present invention, the acceptor element is preferably at least one element among Mn, Co, Ni, and Cr.

Further, in the laminated semiconductor ceramic capacitor of the present invention, the donor element is preferably at least one element selected from La, Nd, Sm, Dy, Nb, and Ta.

Further, in the laminated semiconductor ceramic capacitor of the present invention, a low melting point oxide is preferably contained in an amount of 0.1 mol or less with respect to 100 mol of the Ti element.

Moreover, in the laminated semiconductor ceramic capacitor of the present invention, the low melting point oxide is preferably SiO₂.

Further, a method for manufacturing the laminated semiconductor ceramic capacitor of the present invention is a method for manufacturing a laminated semiconductor ceramic capacitor including a calcined powder preparation step of weighing a Sr compound, a Ti compound and a donor compound in predetermined amounts, mixing/pulverizing these compounds, and then calcining the resulting powder to prepare a calcined powder; a mixed powder preparation step of mixing an acceptor compound with the calcined powder to prepare a mixed powder; a laminate forming step of subjecting the mixed powder to forming process to prepare a ceramic green sheet, and then laminating alternately a conductive film principally composed of Ni and the ceramic green sheet to form a laminate; and a firing step of subjecting the laminate to a primary firing treatment in a reducing atmosphere, and then to a secondary firing treatment in an atmosphere of the air, wherein the ceramic green sheet is prepared so as to have a thickness of a semiconductor ceramic layer of 20 μm or more after firing, and a firing temperature in the primary firing treatment is lower than a calcining temperature in the calcining treatment.

Thereby, a zone of an area in which Ni diffusion has less impact can be easily formed, and it becomes possible to prevent the crystal grain as far as possible from becoming larger. As a result of this, a high-performance laminated semiconductor ceramic capacitor which suppresses variations in characteristics and has excellent reliability can be manufactured.

In the method for manufacturing a laminated semiconductor ceramic capacitor of the present invention, it is preferred that in the calcined powder preparation step, the calcining temperature is set to a temperature of 1300 to 1450° C. to perform the calcining treatment, and in the firing step, a firing temperature in the primary firing treatment is set to a temperature of 1150 to 1250° C. to perform the firing treatment.

As described above, when the primary firing treatment is performed by setting a firing temperature to a low temperature of 1250° C. or less, the diffusion of Ni of an internal electrode material into the semiconductor ceramic layer side can be suppressed, and a laminated semiconductor ceramic capacitor having good apparent relative permittivity εr_{APP} and good insulation resistance can be attained.

In accordance with the laminated semiconductor ceramic capacitor, since a thickness of each of the semiconductor ceramic layers is 20 μm or more, and an average grain diameter of crystal grains in the semiconductor ceramic layers is 1.5 μm or less, it is possible to stably obtain a laminated semiconductor ceramic capacitor having a varistor function which can suppress variations in characteristics between products, and thereby has good electrical characteristics and insulating properties to be excellent in reliability.

That is, by specifying a thickness of each of the semiconductor ceramic layers so as to be 20 μm or more, a zone of an area which is not affected by the Ni diffusion is formed at a central part and in the vicinity of the central part of the semiconductor ceramic layer. Thereby, variations in the apparent relative permittivity εr_{APP} or the insulation resistance between products can be suppressed, and these characteristics can be improved. Moreover, since the average grain diameter of the crystal grains is as small as 1.5 μm or less, oxygen easily goes round in the grain boundary layer during secondary firing, and therefore a grain boundary insulated layer having large insulation resistance can be achieved.

As described above, in accordance with the laminated semiconductor ceramic capacitor of the present invention, by specifying a thickness of each of the semiconductor ceramic layers and an average grain diameter of crystal grains as described above, in combination of both of the resultant effects, it is possible to stably obtain, with a high degree of efficiency, a laminated semiconductor ceramic capacitor which can suppress variations in characteristics between products, and thereby has good electrical characteristics and insulating properties to be excellent in reliability, and is suitable for supporting ESD. Consequently, since one laminated semiconductor ceramic capacitor can realize the functions of a capacitor and a zener diode, the number of components or cost can be reduced, and standardization of design is facilitated, and therefore a laminated semiconductor ceramic capacitor having an added value can be provided.

In accordance with the method for manufacturing the laminated semiconductor ceramic capacitor of the present invention, since the ceramic green sheet is prepared so as to have a thickness of a semiconductor ceramic layer of 20 μm or more after firing, and a firing temperature in the primary firing treatment is lower than a calcining temperature in the calcining treatment, a zone of an area in which Ni diffusion has less impact can be easily formed, and it becomes possible to prevent the crystal grain as far as possible from becoming larger, and thereby, a high-performance laminated semiconductor ceramic capacitor which suppresses variations in characteristics and has excellent reliability can be manufactured.

### BRIEF EXPLANATION OF THE DRAWINGS

FIG. 1 is a cross-sectional view schematically showing an embodiment of a laminated semiconductor ceramic capacitor of the present invention.

FIG. 2 is an enlarged cross-sectional view of a chief part of a laminated semiconductor ceramic capacitor indicating analyzing points in the case of performing elemental analysis by WDX method.

FIG. 3 is a view showing a relationship between a thickness and an apparent relative permittivity εr_{APP} of a semiconductor ceramic layer in examples.

FIG. 4 is a view showing a relationship between a thickness and an intensity ratio x/y of a semiconductor ceramic layer in examples.

FIG. 5 is an electric circuit diagram in the case where a zener diode is connected in parallel to a bypass capacitor disposed to a power source line.

FIG. 6 is an electric circuit diagram in the case where a laminated semiconductor ceramic capacitor is connected to the power source line.

### DETAILED DESCRIPTION OF THE INVENTION

Next, an embodiment of the present invention will be described in detail.

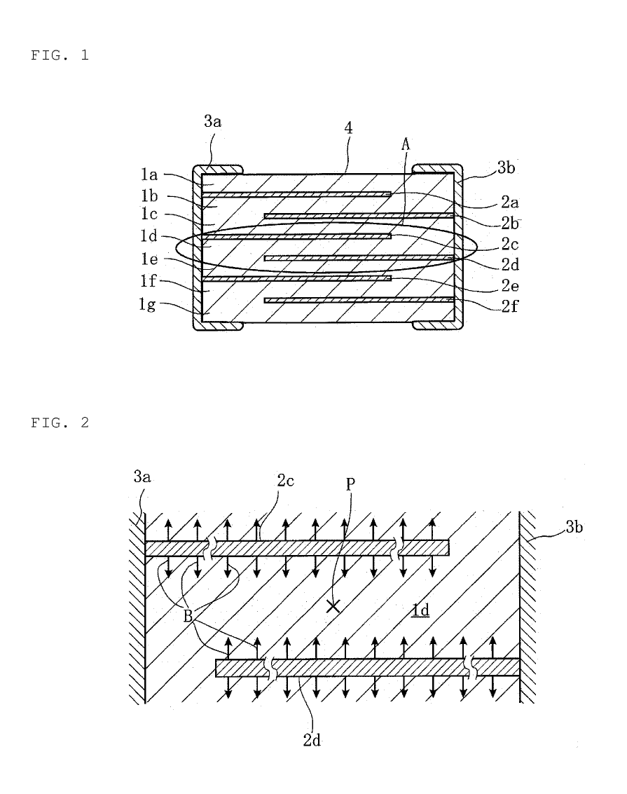

FIG. 1 is a cross-sectional view schematically showing an embodiment of a laminated semiconductor ceramic capacitor of the present invention.

The laminated semiconductor ceramic capacitor includes a component body 4 and external electrodes 3a and 3b formed on both ends of the component body 4.

The component body 4 is made of a laminated sintered body obtained by alternately laminating and sintering a plurality of semiconductor ceramic layers 1a to 1g and a plurality of internal electrode layers 2a to 2f, and the internal electrode layers 2a, 2c, and 2e are exposed at one end surface of the component body 4 and electrically connected to one external electrode 3a, whereas the other internal electrode layers 2b, 2d, and 2f are exposed at the other end surface of the component body 4 and electrically connected to the other external electrode 3b.

A base metal material principally composed of Ni which is low in cost and has good conductivity is used for the internal electrode layers 2a to 2f.

In the semiconductor ceramic layers 1a to 1g, a principal component is composed of a SrTiO₃-based material, a donor element is solid-solved in crystal grains, and an acceptor element is present in a grain boundary layer. That is, the semiconductor ceramic layers 1a to 1g are composed of an aggregate of a crystal grain made of a semiconductor and a grain boundary layer formed around the crystal grain, and crystal grains form a capacitance together with the grain boundary layer interposed therebetween. The semiconductor ceramic layers 1a to 1g are connected to one another in series or in parallel between opposed surfaces of internal electrode layers 2a, 2c, 2e and internal electrode layers 2b, 2d, 2f, and thereby, a desired capacitance is attained as a whole.

Then, in the semiconductor ceramic layers 1a to 1g of the laminated semiconductor ceramic capacitor, a thickness of each of the semiconductor ceramic layers 1b to 1f excluding the semiconductor ceramic layers 1a, 1g for outer layers is 20 μm or more, and an average grain diameter of crystal grains in the semiconductor ceramic layers is 1.5 μm or less. Thereby, a highly reliable laminated semiconductor ceramic capacitor, which can suppress variations in characteristics between products and has good electrical characteristics and insulating properties, can be attained.

Hereinafter, the reason for specifying the thickness of each of the semiconductor ceramic layers and the average grain diameter of crystal grains as described above will be described.

(1) Thickness of Each Semiconductor Ceramic Layer

FIG. 2 is an enlarged view of a section A in FIG. 1. In addition, in FIG. 2, a portion where the semiconductor ceramic layer 1d is sandwiched between the internal electrode layer 2c and the internal electrode layer 2d is shown, and other semiconductor ceramic layers and internal electrode layers have a similar relationship.

That is, while the internal electrode layers 2a to 2f are formed by firing a conductive film obtained by applying a conductive paste, as indicated by an arrow B in FIG. 2, Ni in the conductive film is diffused into a ceramic green sheet side to serve as semiconductor ceramic layers 1a to 1g during firing. The Ni is divalent, has a smaller valence than a tetravalent Ti element, and acts as an acceptor in terms of electric charge. Therefore, in the semiconductor ceramic layers 1b to 1f contributing to the formation of capacitance, in the semiconductor ceramic layers 1a to 1g, an increase in Ni concentration in the semiconductor ceramic layers 1b to 1f causes the apparent relative permittivity εr_{APP} to deteriorate. Further, since Ni penetrates into the crystal grain boundary, there is a possibility that a reduction in insulation resistance may be caused. Moreover, since the apparent relative permittivity εr_{APP} or the insulation resistance varies according to the amount of Ni diffused, variations in the capacitance or the insulation resistance are produced.

However, the amount of Ni diffused has a constant concentration gradient within the semiconductor ceramic layers 1b to 1f, and the Ni concentration is decreased with increasing distance from the internal electrode layers 2a to 2f.

Therefore, when the thickness of each of the semiconductor ceramic layers 1b to 1f is specified to a predetermined thickness or more, a zone of an area, in which Ni is not present at all or only a trace of Ni, not affecting the characteristics, is present, is formed at the central part or in the vicinity of the central part of the semiconductor ceramic layers 1b to 1f away from the internal electrode layers 2a to 2f. Thereby, it becomes possible to avoid the apparent relative permittivity εr_{APP} or the insulation resistance from being reduced, or to avoid these characteristics from varying from product to product.

To that end, the thickness of each of the semiconductor ceramic layers 1b to 1f needs to be at least 20 μm.

That is, when an elemental analysis of the central part or the vicinity of the central part (indicated by a point P in FIG. 2) in a laminating direction of the semiconductor ceramic layers 1b to 1f is performed by WDX method, if the thickness of each of the semiconductor ceramic layers 1b to 1f is 20 μm or more, a ratio x/y (hereinafter, referred to as an “intensity ratio”) of the intensity x of the Ni element to the intensity y of the Ti element can be reduced to 0.06 or less, and thereby, it is possible to avoid the Ni diffusion from having an effect on the characteristics.

A WDX apparatus includes a dispersive crystal, a light-receiving slit, an X-ray detector and the like, and a sample, the dispersive crystal, and the X-ray detector are always located at arc-like positions so as to satisfy the Bragg's condition, and an X-ray takeoff angle to the sample is always kept constant.

In the WDX apparatus, when the sample is irradiated with electron beams, characteristic X-rays are generated by this electron beam irradiation, and an X-ray with a predetermined wavelength is selected from X-ray spectrums of the generated characteristic X-rays by the dispersive crystal and detected by the X-ray detector, and thereby, the intensity of a specific element can be measured and elementary analysis of a fine grain can be performed.

In the present laminated semiconductor ceramic capacitor, as described above, by specifying a thickness of each of the semiconductor ceramic layers 1 so as to be 20 μm or more, the ratio x/y at the central part or in the vicinity of the central part, indicated by the point P, in a laminating direction can be reduced to 0.06 or less, and thereby, the Ni diffusion can be avoided from having an effect on the characteristics.

In addition, when a thickness of any of the semiconductor ceramic layers 1b to 1f is less than 20 μm, the intensity ratio x/y exceeds 0.06, and the semiconductor ceramic layer is affected by the Ni diffusion into the semiconductor ceramic layer 1 to cause the apparent relative permittivity εr_{APP} and the insulation resistance to deteriorate, and these characteristics may vary from product to product.

While an upper limit of a thickness of each of the semiconductor ceramic layers 1b to 1f is not particularly limited, the thickness is preferably 50 μm or less. In the case of a compact laminated semiconductor ceramic capacitor (for example, length 1.0 mm, width 0.5 mm, thickness 0.5 mm), when the thickness becomes larger than 50 μm, it is difficult to attain capacitance of the order of 1 nF.

In addition, since the semiconductor ceramic layers 1a, 1g for exteriors do not have an effect on characteristics, the thickness of the layers is not particularly limited, and may be less than 20 μm.

(2) Average Grain Diameter of Crystal Grain

In the manufacturing process of the above-mentioned laminated semiconductor ceramic capacitor, the ceramic is brought into a semiconductor by the primary firing treatment in a reducing atmosphere, and subsequently the secondary firing treatment is performed in an atmosphere of the air to allow oxygen to be diffused in the crystal grain boundary through reoxidation treatment. Thereby, the crystal grain boundary is brought into an insulated layer (grain boundary insulated layer), and Schottky barrier is formed in the crystal grain boundary and insulation resistance can be improved.

However, when the average grain diameter of the crystal grains is more than 1.5 μm, since the average grain diameter is too large and oxygen hardly goes round during secondary firing, there is a possibility that formation of a Schottky barrier may be insufficient to cause insulation resistance to deteriorate.

Thus, in the present embodiment, the average grain diameter of the crystal grains is adapted to be 1.5 μm or less.

In the above-mentioned laminated semiconductor ceramic capacitor, as described above, since a thickness of each of the semiconductor ceramic layers 1b to 1f is 20 μm or more and the average grain diameter of the crystal grains in the semiconductor ceramic is 1.5 μm or less, the semiconductor ceramic layers 1b to 1f can suppress the impact of Ni diffusion and can form a desired Schottky barrier, and therefore it is possible to obtain a high-performance laminated semiconductor ceramic capacitor which can achieve good electrical characteristics and insulating properties while suppressing the variations in a capacitance or insulation resistance, has high reliability, and is suitable for ESD countermeasure.

Accordingly, since one laminated semiconductor ceramic capacitor can realize the functions of a capacitor and a zener diode, the number of components or cost can be reduced, and standardization of design is facilitated, and therefore a laminated semiconductor ceramic capacitor having an added value can be provided.

In addition, in the present embodiment, a compounding molar ratio m of a Sr site to a Ti site is preferably adjusted so as to satisfy the relational expression 0.990≦m≦1.010.

That is, by containing Sr in excess of stoichiometric composition, Sr, which is deposited in the crystal grain boundary without being solid-solved in the crystal grains, suppresses the grain growth, and therefore fine crystal grains are obtained. Since the crystal grain becomes fine, oxygen easily goes round in a crystal grain boundary, and therefore the formation of a Schottky barrier is promoted and good insulation resistance can be ensured.

However, when the compounding molar ratio m is more than 1.010, since the precipitation of Sr not solid-solved in the crystal grain on the grain boundary is increased to excessively increase the thickness of the grain boundary insulating layer, there is a possibility that an excessive reduction in the capacitance may be caused.

On the other hand, when containing Ti in excess of stoichiometric composition, insulation resistance which can be adequately used practically can be ensured although the crystal grain becomes large slightly and insulation resistance tends to decease, and further a good ESD withstand voltage can be maintained.

However, when the compounding molar ratio m is less than 0.990, the average grain diameter of the crystal grains becomes excessively larger, thereby resulting in a significant decrease in insulating property, and moreover, in a decrease in ESD withstand voltage.

Accordingly, the compounding molar ratio m is preferably adjusted so as to satisfy the relational expression 0.990≦m≦1.010.

The donor element is allowed to be solid-solved in the crystal grains in order to bring the ceramic into a semiconductor by the firing treatment in a reducing atmosphere described above, and the content of the donor element is not particularly limited. However, when the donor element is less than 0.2 mol with respect to 100 mol of the Ti element, there is a possibility that the capacitance may be decreased excessively. On the other hand, when the donor element is greater than 1.2 mol with respect to 100 mol of the Ti element, there is a possibility that this may cause an allowable temperature range for the firing temperature to be narrowed.

Therefore, the molar content of the donor element may be 0.2 mol to 1.2 mol, and preferably 0.4 mol to 1.0 mol with respect to 100 mol of the Ti element.

Such the donor element is not particularly limited, and for example, La, Nd, Sm, Dy, Nb, and Ta can be used.

Further, the acceptor element is present in the grain boundary insulating layer as described above. The grain boundary insulating layer forms an energy level (grain boundary level) which is electrically activated to promote the formation of a Schottky barrier, and therefore insulation resistance can be improved and a laminated semiconductor ceramic capacitor having good insulating properties can be attained. However, when the molar content of the acceptor element is more than 0.7 mol with respect to 100 mol of the Ti element, it is not preferred since reduction in an ESD withstand voltage is caused.

Therefore, the molar content of the acceptor element is 0.7 mol or less (however, not including 0 mol), and preferably 0.3 to 0.5 mol with respect to 100 mol of the Ti element.

Further, while this acceptor element is not particularly limited, Mn, Co, Ni, Cr, etc. can be used, and in particular, Mn is preferably used.

It is also preferable to add a low melting point oxide to the semiconductor ceramic layers 1a to 1g in an amount of 0.1 mol or less with respect to 100 mol of the Ti element, and the addition of this type of a low melting point oxide can improve the sinterability, and promote the segregation of the acceptor element in the grain boundary.

In addition, the molar content of the low melting point oxide was set to the range mentioned above because the molar content greater than 0.1 mol with respect to 100 mol of the Ti element may possibly lead to an excessive reduction in capacitance, thereby resulting in a failure to achieve desired electrical characteristics.

The low melting point oxide is not particularly limited, SiO₂, glass-ceramic containing B or an alkali metal element (such as K, Li, and Na), copper-tungsten salts, etc. can be used, and among these, SiO₂ is preferably used.

Next, an embodiment will be described with reference to a method for manufacturing the laminated semiconductor ceramic capacitor.

First, as ceramic raw materials, a Sr compound such as SrCO₃ or the like, a donor compound containing a donor element such as La, Sm or the like, and a Ti compound having a fine particle size, for example, TiO₂ having a specific surface area of 10 m²/g or more (average grain diameter: about 0.1 μm or less) are prepared, and weighed in a predetermined amount, respectively.

Then, a predetermined amount (for example, 1 to 3 parts by weight) of a dispersant is added to these weighed materials, and then the resulting mixture is charged into a ball mill with a pulverizing medium such as PSZ (partially stabilized zirconia) balls and pure water, and adequately wet-mixed in the ball mill to prepare a slurry.

Next, this slurry is evaporated to dryness, and then subjected to a calcination treatment at a predetermined temperature (for example, 1300° C. to 1450° C.) for about 2 hours in an atmosphere of the air to prepare a calcined powder having a donor element solid-solved.

Then, a predetermined amount of an acceptor compound containing an acceptor element such as Mn, Co or the like is weighed, and a predetermined amount of a low melting point oxide such as SiO₂ is weighed as required. Next, these acceptor compound and low melting point oxide are mixed with the calcined powder, and pure water and an organic dispersant are added, and the resulting mixture is charged into a ball mill again with the pulverizing medium and adequately wet-mixed in the ball mill. Thereafter, the resulting mixture is evaporated to dryness, and heat-treated at a predetermined temperature (for example, 500° C. to 700° C.) for about 5 hours in an atmosphere of the air to prepare a mixed powder.

Next, an organic solvent such as toluene, alcohol or the like, an organic binder, a plasticizer, and a surfactant are appropriately added, and the resulting mixture is adequately wet-mixed to obtain a ceramic slurry.

Next, the ceramic slurry is subjected to forming process by using a forming processing method such as a doctor blade method, a lip coater method, or a die coater method to prepare a ceramic green sheet so as to be 20 μm or more in thickness after firing. In addition, the ceramic green sheet to be disposed in a portion contributing to characteristics needs to be prepared so as to be 20 μm or more in thickness after firing, as described above, but the thickness after firing of the ceramic green sheet for exteriors is not particularly limited, and may be any thickness.

Then, a conductive paste for internal electrodes predominantly composed of Ni is used to be transferred onto the ceramic green sheet by using a screen printing method, a gravure printing method, a vacuum deposition method, or a sputtering method, thereby forming a conductive film with a predetermined pattern on the surface of the ceramic green sheet.

Then, a plurality of ceramic green sheets having the conductive films formed thereon are laminated in a predetermined direction, and a ceramic green sheet for exteriors not having conductive films formed is laminated, and then the laminated ceramic green sheets are pressure bonded, and cut into a predetermined dimension to prepare a laminate.

Thereafter, the laminate is subjected to a debinder treatment at a temperature of 300 to 500° C. for about 2 hours in a nitrogen atmosphere. Subsequently, the laminate is subjected to primary firing at a temperature of 1150 to 1250° C. for about 2 hours to be brought into a semiconductor in a firing furnace brought into a reducing atmosphere, in which a ratio between H₂ gas flow rate and N₂ gas flow rate is adjusted to a predetermined value (for example, H₂/N₂=0.025/100 to 1/100).

As described above, by setting a firing temperature (1150 to 1250° C.) in the primary firing treatment to a temperature lower than a calcining temperature (1300 to 1450° C.) in the calcining treatment, grain growth of the crystal grain is hardly promoted during the primary firing treatment, and therefore the crystal grain can be prevented from becoming larger and an average grain diameter of crystal grains can be easily 1.5 μm or less.

Then, after thus bringing the laminate into a semiconductor, a secondary firing is carried out at a low temperature of 600 to 900° C. for about 1 hour in an atmosphere of the air to reoxidize the semiconductor ceramic. That is, in the secondary firing, since an average grain diameter of crystal grains is 1.5 μm or less, oxygen easily goes round throughout a grain boundary layer, and therefore desired reoxidation is performed to allow a crystal grain boundary to become an insulated layer, and thereby, a component body 4 composed of a laminated sintered body having an internal electrode 2 embedded is prepared.

Thereafter, a conductive paste for external electrodes is applied onto both ends of the component body 4, and subjected to a firing treatment to form external electrodes 3a and 3b, thereby manufacturing a laminated semiconductor ceramic capacitor.

In addition, for a method for forming the external electrodes 3a and 3b, the external electrodes 3a and 3b may be formed by printing, vacuum deposition, sputtering, or the like. In addition, the conductive paste for external electrodes may be applied onto the both ends of the unfired laminate, and then subjected to a firing treatment at the same time as the laminate.

While the conductive material contained in the conductive paste for external electrodes is also not particularly limited, it is preferred to use a material such as Ga, In, Ni, or Cu, and further it is also possible to form an Ag electrode on these electrodes.

In the present embodiment as described above, since the ceramic green sheet is prepared so as to have a thickness of each of the semiconductor ceramic layers of 20 μm or more after firing, and a firing temperature (1150 to 1250° C.) in the primary firing treatment is lower than a calcining temperature (1300 to 1450° C.) in the calcining treatment, a zone of an area, in which Ni is not present at all or only a trace of Ni, not affecting the characteristics, is present, is formed at the central part or in the vicinity of the central part in a laminating direction of the semiconductor ceramic layers 1a to 1f, and the average grain diameter of the crystal grains can be 1.5 μm or less because the crystal grain can be prevented as far as possible from becoming large during the primary firing. Accordingly, a high-performance laminated semiconductor ceramic capacitor having a varistor function suitable for supporting ESD, in which electrical characteristics and insulating properties are good and variations in characteristics are suppressed, resulting in excellent reliability, can be stably manufactured.

In addition, the present invention is not limited to the embodiment described above. For example, while the solid solution is prepared by a solid phase method in the above embodiment, the method for preparing the solid solution is not particularly limited, and any methods can be employed, such as a hydrothermal synthesis method, a sol-gel method, a hydrolysis method, and a coprecipitation method.

Next, examples of the present invention will be described specifically.

### Example 1

### Preparation of Samples

As ceramic raw materials, SrCO₃, TiO₂ having a specific surface area of 30 m²/g (average grain diameter: about 30 nm), and LaCl₃ as a donor compound were prepared. Then, LaCl₃ was weighed in such a way that the content of La was 0.8 mol with respect to 100 mol of the Ti element, and further SrO₃ and TiO₂ were weighed in such a way that the compounding molar ratio m of a Sr site to a Ti site (=Sr site/Ti site) was set as shown in Table 1.

Then, 3 parts by weight of ammonium polycarboxylate were added as a dispersant to 100 parts by weight of these weighed materials, and then the resulting mixture was charged into a ball mill with PSZ balls of 2 mm in diameter as a pulverizing medium and pure water, and subjected to wet mixing for 16 hours in the ball mill to prepare a slurry.

Next, this slurry was evaporated to dryness, and then subjected to a calcination treatment at a calcining temperature shown in Table 1 for 2 hours in an atmosphere of the air to obtain a calcined powder with La solid-solved in crystal grains.

Next, MnCO₃ was added to the calcined powder in such a way that the content of a Mn element as an acceptor element was a value shown in Table 1 with respect to 100 mol of the Ti element, and further tetraethoxysilane (Si(OC₂H₅)₄) was added to the calcined powder in such a way that the molar content of SiO₂ was 0.1 mol with respect to 100 mol of the Ti element, and further ammonium polycarboxylate as a dispersant was added to the calcined powder in such a way that the content of the dispersant was 1% by weight. Then, the resulting mixture was charged into a ball mill again with PSZ balls of 2 mm in diameter and pure water, and wet-mixed for 16 hours in the ball mill. In addition, in the present example, MnCO₃ was added to the calcined powder, but a MnCl₂ solution or a Mn sol solution may be added.

Thereafter, the resulting mixture was evaporated to dryness, and then heat-treated at a temperature of 600° C. for 5 hours in an atmosphere of the air to remove an organic component such as the dispersant and obtain a mixed powder.

Next, an organic solvent such as toluene, alcohol or the like, and a dispersant were added to the mixed powder in an appropriate amount, and the resulting mixture was charged into a ball mill again with PSZ balls of 2 mm in diameter, and mixed in a wet way for 16 hours in the ball mill. Thereafter, polyvinyl butyral (PVB) as an organic binder and dioctyl phthalate (DOP) as a plasticizer, and further a cationic surfactant were added in appropriate amounts, and wet-mixed for 1.5 hours to prepare a ceramic slurry.

Next, using a lip coater method, the ceramic slurry was subjected to forming process and a ceramic green sheet was prepared so as to have a thickness of a semiconductor ceramic layer of a value shown in Table 1 after firing. Then, a conductive paste for internal electrodes predominantly composed of Ni was used to be applied onto the ceramic green sheet by screen printing, thereby forming a conductive film with a predetermined pattern on the surface of the ceramic green sheet.

Then, 5 ceramic green sheets having the conductive films formed thereon were laminated in a predetermined direction, and then a ceramic green sheet for exteriors not having conductive films formed thereon was placed on each of a top and a bottom surfaces, and the laminated ceramic green sheets were subjected to thermocompression bonding so as to have a thickness of about 0.6 mm in the subsequent process to obtain a block body in which the ceramic green sheets and internal electrodes were alternately laminated on each other.

Thereafter, the block was cut into a piece with a predetermined dimension to form a laminate, and the laminate was subjected to a debinder treatment at a temperature of 400° C. for 2 hours in a nitrogen atmosphere. Then, the laminate was subjected to primary firing at a firing temperature shown in Table 1 for 2 hours in a reducing atmosphere composed of H₂ flow and N₂ flow adjusted in proportions of 1:100 to be brought into a semiconductor.

Next, a secondary firing was carried out at a temperature of 700° C. for 1 hour in an atmosphere of the air to reoxidize the semiconductor ceramic, and thereby, oxygen was dispersed in the grain boundary to form a grain boundary insulating layer, and then an end face was polished to prepare a component body.

Then, sputtering was applied to both end faces of the component body to form external electrodes of three-layer structure including a Ni—Cr layer, a Ni—Cu layer, and an Ag layer. Then, electrolytic plating was applied to form a Ni film and a Sn film sequentially on the surfaces of the external electrodes, thereby preparing samples of sample numbers 1 to 12. The outer dimension of each of the obtained samples was 1.0 mm in length L, 0.5 mm in width W, and 0.5 mm in thickness T. In addition, the effective number of laminated semiconductor ceramic layers was 4.

[Evaluations of Samples]

Each of the samples of the sample Nos. 1 to 12 was broken, and the broken sample was polished and etched chemically to enable observation of a crystal grain diameter. Then, a SEM photograph was taken with a scanning electron microscope (SEM) and the photograph was image-analyzed to determine the average grain diameter (average crystal grain diameter) of the crystal grains.

Further, capacitances of 100 samples for each of the sample Nos. 1 to 12 were respectively measured under the conditions of a frequency of 1 kHz and a voltage of 1 V by using an impedance analyzer (manufactured by Agilent Technologies, Inc.: HP4194A) to determine an average value of the capacitance and 3CV (=3×σ/ξ, σ: standard deviation, ξ: average value) as a variation index. Further, the apparent relative permittivity εr_{APP} was calculated from an average of the capacitance values and a dimension of the sample.

Moreover, a DC voltage of 50 V was applied to 100 samples for each of the sample Nos. 1 to 12 for 1 minute, and insulation resistance was measured from its leak current. Then, an average value and a minimum value of the specific resistances log ρ were determined from an average value and a minimum value of the insulation resistance and a sample dimension of the samples.

Then, each of the samples of the sample Nos. 1 to 12 was polished, and the intensity ratio x/y at the central part in a laminating direction of the semiconductor ceramic layers was determined by using the WDX method, and thereby, an amount of the Ni diffusion was evaluated.

Table 1 shows the compounding molar ratio, the molar content of Mn and SiO₂ with respect to 100 mol of Ti, the calcining temperature, the firing temperature (primary firing) and measured results of the sample Nos. 1 to 12.

TABLE 1

| | Com- | | | | | Average | | | | | Specific | | |
|---|---|---|---|---|---|---|---|---|---|---|---|---|---|
| | pounding | | | Calcining | Firing | Crystal | Thickness of | Capacitance | | Apparent | Resistance log | | |
| | Molar | | | Tem- | Tem- | Grain | Semiconductor | Average | | Relative | ρ (ρ: Ω cm) | | Intensity |
| Sample | Ratio | Mn | SiO₂ | perature | perature | Diameter | Ceramic Layer | Value | 3CV | Permittivity | Average | Minimum | Ratio x/y |
| No. | m (—) | (mol) | (mol) | (° C.) | (° C.) | (μm) | (μm) | (nF) | (%) | εr_{APP} (—) | Value | Value | (—) |
| 1* | 1.000 | 0.3 | 0.1 | 1400 | 1210 | 0.7 | 2.6 | 1.08 | 14.5 | 330 | 9.5 | 7.6 | 0.13 |
| 2* | 1.000 | 0.3 | 0.1 | 1400 | 1210 | 0.7 | 6.6 | 0.86 | 12.5 | 665 | 10.8 | 8.1 | 0.09 |
| 3* | 1.000 | 0.3 | 0.1 | 1400 | 1210 | 0.7 | 12 | 0.92 | 10.1 | 1300 | 11.0 | 8.6 | 0.08 |
| 4 | 1.000 | 0.3 | 0.1 | 1400 | 1210 | 0.7 | 22 | 0.70 | 4.8 | 1780 | 11.2 | 10.5 | 0.06 |
| 5 | 1.000 | 0.3 | 0.1 | 1400 | 1210 | 0.8 | 38 | 0.42 | 4.2 | 1870 | 11.1 | 10.7 | 0.05 |
| 6 | 1.000 | 0.3 | 0.1 | 1400 | 1210 | 0.8 | 48 | 0.36 | 3.8 | 1900 | 11.2 | 10.9 | 0.05 |
| 7 | 1.000 | 0.3 | 0.1 | 1400 | 1210 | 0.8 | 87 | 0.19 | 3.7 | 1900 | 11.3 | 10.9 | 0.05 |
| 8 | 1.000 | 0.3 | 0.1 | 1400 | 1210 | 0.8 | 102 | 0.16 | 4.0 | 1900 | 11.1 | 10.8 | 0.05 |
| 9 | 0.990 | 0.3 | 0.1 | 1300 | 1210 | 1.4 | 22 | 0.70 | 4.6 | 1770 | 11.1 | 10.8 | 0.06 |
| 10 | 1.010 | 0.3 | 0.1 | 1400 | 1210 | 0.9 | 22 | 0.75 | 4.7 | 1900 | 11.2 | 10.7 | 0.06 |
| 11 | 1.000 | 0.5 | 0.1 | 1400 | 1210 | 1.1 | 22 | 0.98 | 4.8 | 2500 | 11.2 | 10.7 | 0.06 |
| 12* | 1.000 | 0.3 | 0.1 | 1200 | 1300 | 2.2 | 22 | 0.83 | 9.2 | 2100 | 9.3 | 7.1 | 0.11 |

*out of the scope of the present invention

In the sample No. 1, 3CV of the capacitance was as large as 14.5%, the apparent relative permittivity εr_{APP} was as extremely low as 330, and the specific resistance log ρ was also as small as 9.5 for an average value and 7.6 for a minimum value. The reason for this is probably that since the thickness of the semiconductor ceramic layer was as small as 2.6 μm, the intensity ratio x/y was as large as 0.13, and the characteristics were affected by the Ni diffusion in the semiconductor ceramic layer.

Also in the sample No. 2, 3CV of the capacitance was as large as 12.5%, the apparent relative permittivity εr_{APP} was 665, and the specific resistance log ρ was also as small as 10.8 for an average value and 8.1 for a minimum value. The reason for this is probably that although the thickness (=6.6 μm) of the semiconductor ceramic layer was larger than that of the sample No. 1, the intensity ratio x/y was still as large as 0.09, and therefore the characteristics were affected by the Ni diffusion in the semiconductor ceramic layer approximately as with the sample No. 1.

In the sample No. 3, 3CV of the capacitance was still as large as 10.1%, the apparent relative permittivity εr_{APP} was as low as 1300, and the specific resistance log ρ was also as small as 11.0 for an average value and 8.6 for a minimum value. The reason for this is probably that although the thickness (=12 μm) of the semiconductor ceramic layer was larger than those of the sample Nos. 1 and 2 and the characteristics were improved, the thickness was not adequately large to such an extent that the characteristics were not affected by the Ni diffusion, the intensity ratio x/y was as large as 0.08, and therefore the characteristics were affected by the Ni diffusion in the semiconductor ceramic layer.

On the other hand, in the sample No. 12, since the thickness of the semiconductor ceramic layer was as large as 22 μm, the apparent relative permittivity εr_{APP} was as high as 2100 or more, but the 3CV of the capacitance was as large as 9.2%, and the specific resistance log ρ was as small as 9.3 for an average value and 7.1 for a minimum value. The reason for this is probably that since the firing temperature was higher than the calcining temperature, the crystal grain becomes larger by the grain growth and the average crystal grain diameter becomes as large as 2.2 μm, and therefore oxygen does not go round during firing, and the specific resistance log ρ was deteriorated. Moreover, the firing temperature was as high as 1300° C. to promote the diffusion of Ni, and even although the thickness of the semiconductor ceramic layer was made as large as 22 μm, the intensity ratio x/y was as large as 0.11. Consequently, the characteristics were affected by the Ni diffusion in the semiconductor ceramic layer, resulting in a reduction in specific resistance and an increase in 3CV of the capacitance.

Compared with these, in the samples of the sample Nos. 4 to 11, since the firing temperature was lower than the calcining temperature and the thickness of the semiconductor ceramic layer was 20 μm or more and the average crystal grain diameter was 1.5 μm or less, 3CV of the capacitance could be suppressed to 3.7 to 4.8%, the apparent relative permittivity εr_{APP} of 1700 or more could be ensured, the specific resistance log ρ was as small as 11.1 to 11.3 for an average value and 10.7 to 10.9 for a minimum value, variations between the samples became small, and therefore a laminated semiconductor ceramic capacitor having good apparent relative permittivity εr_{APP} and good specific resistance log ρ could be obtained.

However, in the sample Nos. 7 and 8, since the thicknesses of the semiconductor ceramic layers were as large as 87 μm and 102 μm, respectively, the capacitance was found to decrease.

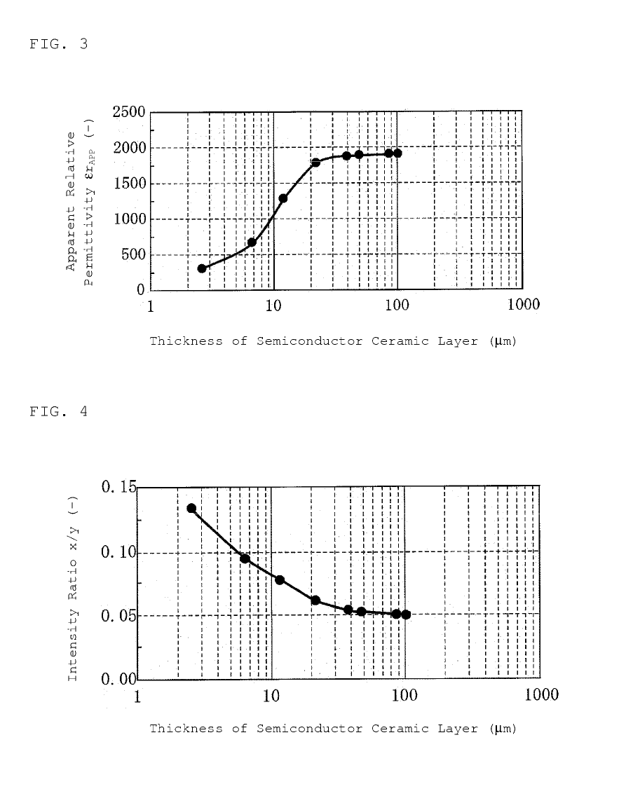

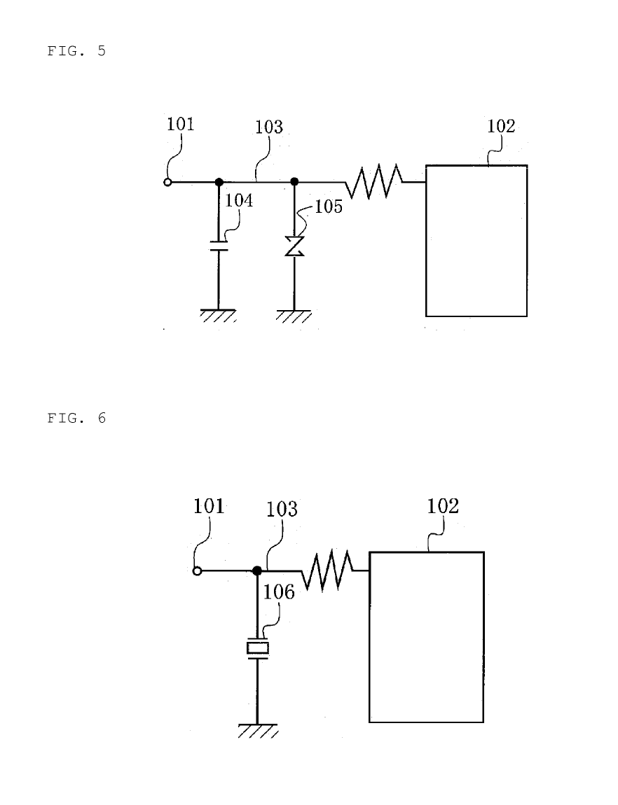

FIG. 3 shows a relationship between a thickness and an apparent relative permittivity εr_{APP} of a semiconductor ceramic layer.

As is apparent from FIG. 3, it was found that the apparent relative permittivity εr_{APP} is stable when the thickness of the semiconductor ceramic layer is 20 μm or more, but the apparent relative permittivity εr_{APP} is decreased when the thickness of the semiconductor ceramic layer becomes smaller.

FIG. 4 shows a relationship between a thickness and an intensity ratio x/y of the semiconductor ceramic layer.

As is apparent from FIG. 4, it was found that the intensity ratio x/y, namely, the impact of the Ni diffusion, is stable when the thickness of the semiconductor ceramic layer is 20 μm or more, and the intensity ratio x/y is increased and a Ni concentration is increased at the central part of the semiconductor ceramic layer when the thickness of the semiconductor ceramic layer is small.

Further, as is apparent in contrasting FIG. 3 with FIG. 4, there is a correlation among the thickness, the apparent relative permittivity εr_{APP}, and the intensity ratio x/y of the semiconductor ceramic layer, and the apparent relative permittivity εr_{APP} is stable in the case where the intensity ratio x/y is 0.06 or less, in which the thickness of the semiconductor ceramic layer is 20 μm or more.

### Example 2

A ceramic slurry was prepared by the same method/procedure as in the example 1 except that the compounding molar ratio m of a Sr site to a Ti site was 1.000, the molar content of Mn was 0.3 mol with respect to 100 mol of the Ti element, and the molar content of SiO₂ was 0.1 mol with respect to 100 mol of the Ti element. In addition, the calcining treatment was performed at a calcining temperature shown in Table 2.

Next, using a lip coater method, the ceramic slurry was subjected to forming process and a ceramic green sheet was prepared so as to have a thickness of a semiconductor ceramic layer of a value shown in Table 2 after firing. Then, a conductive paste for internal electrodes predominantly composed of Ni was used to be applied onto the ceramic green sheet by screen printing, thereby forming a conductive film with a predetermined pattern on the surface of the ceramic green sheet.

Then, the effective number shown in Table 2 of ceramic green sheets having the conductive films formed thereon were laminated in a predetermined direction, and then a ceramic green sheet for outer layers not having conductive films formed thereon was placed on each of a top and a bottom surfaces, and the laminated ceramic green sheets were subjected to thermocompression bonding so as to have a thickness of about 0.6 mm in the subsequent process to obtain a block body in which the ceramic green sheets and internal electrodes were alternately laminated to each other.

In addition, since the thicknesses of the semiconductor ceramic layer after firing were different, the effective number of lamination was adjusted so that a capacitance was about 1 nF.

a) Samples of sample Nos. 21 to 23 were prepared by the same method/procedure as in the example 1 in the subsequent process. In addition, the primary firing treatment was carried out at a firing temperature shown in Table 2.

Next, 100 samples for each of the sample Nos. 21 to 23 were respectively positively and negatively charged ten times and discharged by contact, and subjected to an ESD breakdown test at 30 kV according to IEC61000-4-2 (International Standard) which is an immunity test standard of ESD.

Table 2 shows manufacturing conditions and measured results in each sample of the sample Nos. 21 to 23.

TABLE 2

| | | | | | | | | | Number of |
|---|---|---|---|---|---|---|---|---|---|
| | | | | | | | Thickness of | | Failures in |
| | Compounding | | | Calcining | Firing | Effective | Semiconductor | Average | ESD |
| Sample | Molar Ratio | Mn | SiO₂ | Temperature | Temperature | Number of | Ceramic Layer | Crystal Grain | Breakdown |
| No. | m (—) | (mol) | (mol) | (° C.) | (° C.) | Lamination | (μm) | Diameter (μm) | Test |
| 21* | 1.000 | 0.3 | 0.1 | 1400 | 1210 | 5 | 12 | 0.7 | 15/100 |
| 22 | 1.000 | 0.3 | 0.1 | 1400 | 1210 | 6 | 22 | 0.7 | 0/100 |
| 23* | 1.000 | 0.3 | 0.1 | 1200 | 1300 | 5 | 22 | 2.2 | 28/100 |

*out of the scope of the present invention

In the case of the sample No. 21, 15 samples among 100 samples were broken in the ESD breakdown test at 30 kV. The reason for this is probably that since the thickness of the semiconductor ceramic layer was as small as 12 v, variations in a specific resistance log ρ became large due to the influence of the diffusion of Ni, and therefore the immunity to ESD varied from sample to sample.

Further, in the case of the sample No. 23, 28 samples among 100 samples were broken. The reason for this is probably that although the thickness of the semiconductor ceramic layer was as large as 22 v, the firing temperature was higher than the calcining temperature to allow the crystal grain to become large, and therefore the diffusion of Ni into the semiconductor ceramic layer was promoted, resulting in large variations in the specific resistance log p, and variations in the immunity to ESD between samples.

On the other hand, in the case of the sample No. 22, the firing temperature was lower than the calcining temperature, the thickness of the semiconductor ceramic layer was 22 μm, and the average crystal grain diameter was 0.7 μm, and therefore it was found that there was no sample which was broken among 100 samples.

It becomes possible to realize a laminated semiconductor ceramic capacitor with a varistor function which has small variations in characteristics between products, and good electrical characteristics and insulating properties, resulting in excellent reliability, and is suitable for mass production, and one element can serve as both of a capacitor and a zener diode.

### DESCRIPTION OF REFERENCE SYMBOLS

1a to 1g semiconductor ceramic layer
2a to 2f internal electrode layer
3a, 3b external electrode
4 component body (laminated sintered body)

1. A laminated semiconductor ceramic capacitor with a varistor function comprising:
a laminated sintered body having a plurality of semiconductor ceramic layers of a SrTiO₃-based grain boundary insulated semiconductor ceramic and a plurality of internal electrode layers predominantly composed of Ni; and
external electrodes on opposed ends of the laminated sintered body, the external electrodes electrically connected to the internal electrode layers,
wherein a thickness of each of the semiconductor ceramic layers is 20 μm or more, and an average grain diameter of crystal grains in the semiconductor ceramic layers is 1.5 μm or less.

2. The laminated semiconductor ceramic capacitor with a varistor function according to claim 1, wherein a ratio x/y of an intensity x of the Ni to an intensity y of the Ti is 0.06 or less.

3. The laminated semiconductor ceramic capacitor with a varistor function according to claim 2, wherein the ratio x/y is determined by an elemental analysis of a central part or a vicinity of the central part in a laminating direction of the semiconductor ceramic layers by a wavelength dispersive fluorescent X-ray analysis method.

4. The laminated semiconductor ceramic capacitor with a varistor function according to claim 1, wherein in the SrTiO₃-based grain boundary insulated semiconductor ceramic, a compounding molar ratio m of a Sr site to a Ti site satisfies a relational expression 0.990≦m≦1.010, a donor element is solid-solved in crystal grains, and an acceptor element is present in a grain boundary layer in a range of 0.7 mol or less, and greater than 0 mol, with respect to 100 mol of the Ti.

5. The laminated semiconductor ceramic capacitor with a varistor function according to claim 4, wherein the acceptor element is contained in an amount of 0.3 to 0.5 mol with respect to 100 mol of the Ti.

6. The laminated semiconductor ceramic capacitor with a varistor function according to claim 5, wherein the acceptor element is at least one element among Mn, Co, Ni, and Cr.

7. The laminated semiconductor ceramic capacitor with a varistor function according to claim 4, wherein the acceptor element is at least one element among Mn, Co, Ni, and Cr.

8. The laminated semiconductor ceramic capacitor with a varistor function according to claim 4, wherein the donor element is at least one element selected from La, Nd, Sm, Dy, Nb, and Ta.

9. The laminated semiconductor ceramic capacitor with a varistor function according to claim 1, wherein in the SrTiO₃-based grain boundary insulated semiconductor ceramic, a compounding molar ratio m of a Sr site to a Ti site satisfies a relational expression 0.990≦m≦1.010.

10. The laminated semiconductor ceramic capacitor with a varistor function according to claim 1, wherein in the SrTiO₃-based grain boundary insulated semiconductor ceramic, a donor element is solid-solved in crystal grains.

11. The laminated semiconductor ceramic capacitor with a varistor function according to claim 1, wherein in the SrTiO₃-based grain boundary insulated semiconductor ceramic, an acceptor element is present in a grain boundary layer in a range of 0.7 mol or less, and greater than 0 mol, with respect to 100 mol of the Ti.

12. The laminated semiconductor ceramic capacitor with a varistor function according to claim 1, wherein an oxide is contained in the semiconductor ceramic layers in an amount of 0.1 mol or less with respect to 100 mol of the Ti element.

13. The laminated semiconductor ceramic capacitor with a varistor function according to claim 12, wherein the oxide is SiO₂.

14. A method for manufacturing a laminated semiconductor ceramic capacitor with a varistor function, the method comprising:
weighing, mixing and calcining a Sr compound, a Ti compound and a donor compound in predetermined amounts to prepare a calcined powder;
mixing an acceptor compound with the calcined powder to prepare a mixed powder;
subjecting the mixed powder to a forming process to prepare a ceramic green sheet, and then alternately laminating a conductive film principally composed of Ni and the ceramic green sheet to form a laminate; and
subjecting the laminate to a primary firing treatment in a reducing atmosphere, and then to a secondary firing treatment in an atmosphere of the air,
wherein the ceramic green sheet is prepared so as to have a thickness of a semiconductor ceramic layer of 20 μm or more after the primary and secondary firing treatments, and
a firing temperature in the primary firing treatment is lower than a calcining temperature during calcining.

15. The method for manufacturing a semiconductor ceramic capacitor according to claim 14, wherein the calcining temperature is 1300 to 1450° C., and the firing temperature in the primary firing treatment is 1150 to 1250° C.

16. The method for manufacturing a semiconductor ceramic capacitor according to claim 14, further comprising mixing an oxide with the calcined powder.

17. The method for manufacturing a semiconductor ceramic capacitor according to claim 16, wherein the oxide is SiO₂.
